(19) United States
(12) Patent Application Publication
(10) Pub. No.: US 2026/0228254 A1
(43) Pub. Date: Aug. 6, 2026

(54) GENERATIVE ARTIFICIAL INTELLIGENCE (AI) TO GENERATE INFORMATION RELATED TO A COMPLEX SYSTEM

(71) Applicant: NVIDIA Corporation, Santa Clara, CA (US)

(72) Inventors: Ryan Albrignt, Beaverton, OR (US); Ruthie D. Lyle, Durham, NC (US); Elad Mentovich, Tel Aviv (IL); Siddha Ganju, San Jose, CA (US); Kenneth W. Hester, Magnolia, TX (US)

(21) Appl. No.: 19/047,516

(22) Filed: Feb. 6, 2025

(51) Int. Cl. G06F 16/3329; G06F 11/07; H04L 41/5074

(52) U.S. Cl. CPC G06F 16/33295; G06F 11/0793; H04L 41/5074

(57) ABSTRACT

In various examples, system, methods, and techniques for implementing a generative artificial intelligence (AI) to generate information related to a system (e.g., a manufacturing facility). In some embodiments, the generative AI generates a potential answer until the potential answer is responsive to prompt(s) provided by a requestor. In at least one embodiment, neural network(s) are used to generate output based at least on the prompt(s). The output may include an answer, a request for information, and/or a request to generate a tool. In at least one embodiment, the neural network(s) are used to generate the tool based at least on the request to generate the tool if the output includes the request to generate the tool. A potential answer includes the answer if the output included the answer, and/or the results obtained by using the tool if the tool was generated and used to obtain the results.

### BACKGROUND

Before a hardware product, such as a processor, leaves a manufacturing facility, software may be executed on that product to test functionality of the product. Results (e.g., diagnostic logs) generated by such software are stored and their values may change over time. Engineers create tools (e.g., scripts) to generate reports and/or data (e.g., using the stored logs) to evaluate manufacturing processes related to the products (e.g., what was the failure rate of a particular high-speed interface for a particular product line during a particular time period versus a different time period). Unfortunately, creating such tools is time consuming and obtaining an answer to a particular question can be inefficient because the answer obtained by a particular tool may not actually align with the results requested and/or actually needed.

### SUMMARY

Embodiments of the present disclosure relate to a generative artificial intelligence (AI) to generate information related to a system (e.g., a manufacturing system and/or another complex system). In some embodiments, the generative AI includes one or more AI models (e.g., neural network(s)) that generate information related to the system. The AI model(s) may generate a potential answer to at least one prompt received from a requester (e.g., a user, software, a machine, a system, an AI agent, an automated process, etc.) until the potential answer is responsive to the prompt(s). The prompt(s) may be presented in natural language. The AI model(s) may generate the potential answer by determining, based at least on the prompt(s), whether to request additional information, construct a tool (e.g., a script), and/or provide an answer to the prompt(s). The potential answer may include the answer if the AI model(s) generated the answer. The AI model(s) may generate the tool, and the generative AI may cause the tool to be used to obtain data. The potential answer may include the data if the data was obtained. The generative AI may present the potential answer to the requester if the potential answer is responsive to the prompt(s). The AI model(s) may provide the obtained data to a second system, for example, a bug repository, and/or to different second software. By way of a non-limiting example, the second system may be a database used to create and/or update a product description for the product. The AI model(s) may generate one or more requests for additional information from the requestor if the potential answer is not responsive to the prompt(s).

In contrast to conventional systems, a generative AI is used to generate information related to a system. For example, instead of human engineers creating tools (e.g., scripts) to generate reports and/or data (e.g., based at least on diagnostic logs, and/or other data related to one or more products and/or manufacturing process(es)) that may be used to evaluate the manufacturing process(es) related to the product(s), the generative AI may be used to generate such information in response to one or more prompts.

### BRIEF DESCRIPTION OF THE DRAWINGS

The present systems and methods for a generative AI to generate information related to a complex system are described in detail below with reference to the attached drawing figures, wherein:

FIG. 1 is an illustration of an example of a requester interacting with a generative AI system, in accordance with some embodiments of the present disclosure;

FIG. 2 is a block diagram of an example system implementing the generative AI system of FIG. 1, in accordance with some embodiments of the present disclosure;

FIG. 3 is a block diagram illustrating example components of the generative AI system of FIG. 1, in accordance with some embodiments of the present disclosure;

FIG. 4 is a flow diagram showing a method for using the generative AI system of FIG. 1 to obtain a response to a request, in accordance with some embodiments of the present disclosure;

FIG. 5 is a flow diagram showing the method for using the generative AI system of FIG. 1 to detect one or more anomalies, and cause tickets to be generated for the anomaly(ies), in accordance with some embodiments of the present disclosure;

FIG. 6 is a block diagram illustrating an example of a processor and storage, in accordance with some embodiments of the present disclosure;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIG. 8 is a block diagram of an example computing device suitable for use in implementing at least some embodiments of the present disclosure; and

FIG. 9 is a block diagram of an example data center suitable for use in implementing at least some embodiments of the present disclosure.

### DETAILED DESCRIPTION

Systems and methods are disclosed related to a generative AI to generate information related to a complex system (e.g., a manufacturing system). The generative AI may create tools (e.g., code, instructions, scripts, macros, etc.) and/or generate information (e.g., data and/or reports) based at least on one or more prompts (e.g., one or more contextual inputs to one or more language models). The generative AI may use available data (e.g., diagnostic logs and/or one or more other types of data) to understand the complex system, and generate results in response to the prompt(s). The prompt(s) may include text (e.g., natural language), audio, image(s), video(s), and/or other types of contextual and/or semantic data. The generative AI includes one or more machine learning models (e.g., one or more neural networks, one or more language models (LM(s)), one or more large language models (LLM(s)), one or more vision language models (VLM(s)), one or more multi-modal language models (MMLM(s)), one or more small language models (SLMs), and/or one or more other types of machine learning models). The generative AI may save time that would otherwise be spent by users (e.g., engineers) creating tools, and/or may be more efficient because the generative AI may use contextual information to align its answers with requests communicated to the generative AI by the prompt(s).

A requester, such as a user, an automated process, software, a machine, a system, an AI agent, etc., may use the generative AI to perform factory failure analysis. For example, the generative AI may generate one or more tools (e.g., computer executable instructions) to parse through large amounts of factory data contextually and generate reports based at least on results obtained using the tool(s). The requester may use the generative AI for contextual tool creation based on one or more prompts (e.g., LLM input request(s)) and/or data (e.g., system data) obtained from and/or associated with at least one other system (e.g., one or more systems of a manufacturing facility or factory). The generative AI may perform inference with respect to complex and/or evolving datasets, such as factory logs and/or diagnostic logs, to provide feedback to the requester, and/or to clarify or otherwise modify the prompt(s) before using the prompt(s) to generate the tool(s). The generative AI may request context information, and add that context information to or use it as a training dataset to train one or more machine leaning processes (e.g., neural network(s), LM(s), and/or others) to provide appropriate inference results in response to one or more queries included in the prompt(s). The generative AI may request context information, and include that context information in the prompt(s) to improve an inference result. The generative AI may use a graph structure to improve a probability of a correct interpretation of a query included in the prompt(s) based on data context and previous similar queries. For example, the generative AI may include at least one LM that implements such as graph structure. The generative AI may use token based feedback to represent cost for determined paths of tool creation and/or report generation. The generative AI may automatically generate tickets, such as one or more bug tickets, one or more Jira tickets, and/or one or more other types of tickets, to address one or more perceived anomalies directed to be found, and/or identified through inference.

The requester may include any technical person wishing to make a request, such as a data analysis request and/or a representation request using natural language. To obtain a response to the request, the generative AI may generate one or more tool(s) to accomplish one or more tasks. The results of the request may include a contextual result based at least on the request and data (e.g., obtained by the tool(s)) upon which the request is to act. If the natural language request is unclear or if context of the data to be acted upon is difficult to infer, the generative AI may respond to the request (e.g., query) with one or more follow up questions, and/or one or more requests for context (e.g., with respect to a nature of the dataset) such that the generative AI may can, if needed, train one or more machine learning processes against the dataset for context relevant to the request (e.g., a query).

Compute time and/or compute cost for a particular response may be communicated to the requester so that the requester may authorize the generative AI expend compute time and/or compute cost to generate the response. The generative AI may use a graph structure to support a ranker and/or improve a probability of a search response. The graph structure models may predict a token cost to execute each of the branched paths. Tokens may represent a value of time and/or compute resources (power, memory, time, etc.) required for each potential generative path. The query included in the prompt(s) may direct the generative AI whether to be more or less greedy without further prompts.

When in the course of perceiving data, the generative AI may identify one or more anomalies and/or directed differences prescribed by the input and automatically generate tickets for action through existing tools and/or infrastructure for the context of the information being manipulated. For example, the generative AI may create and/or update a bug ticket, a JIRA ticket, and/or another anomaly identification and/or correction notification.

The generative AI may be used to perform factory log-based failure analysis. By way of a non-limiting example, the generative AI may be used to analyze Peripheral Component Interconnect Express (PCIE) bit error rates at a factory that builds servers, and may determine, for example, that such bit error rates have increased slightly with respect to a previous manufacturing window. Then, the generative AI may perform one or more actions to address this issue, such as create a ticket, send a notification to a user, send a notification to an automated process, and/or others. This action may be unsupervised, or may be submitted for human review prior to acting.

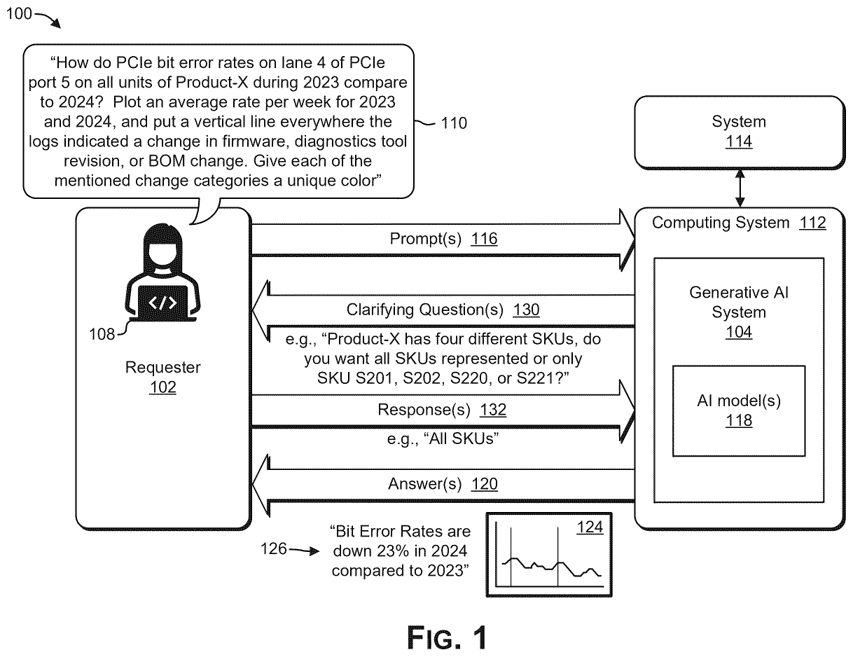

FIG. 1 is an illustration of an example interaction 100 between a requester 102 and a generative AI system 104, in accordance with some embodiments of the present disclosure. The requester 102 may include one or more human users, and/or one or more automated processes (e.g., a process performed by a quality control application, a security application, a safety application, an automated reporting application, a control application, a management application, and/or others). The requester 102 may include and/or be implemented by a computing device 108 connected (e.g., by a network) to a computing system 112 implementing the generative AI system 104. For example, the requester 102 may include a human user operating the computing device 108, and/or the requester 102 may include an automated process being performed by the computing device 108. By way of another non-limiting example, the requester 102 may be the generative AI system 104 itself, another generative AI system, and/or the others.

In FIG. 1, the requester 102 has a request 110 for information related to a system 114 (e.g., a complex system, a large system, a manufacturing system, and/or others). For example, in FIG. 1, the request 110 is seeking the following information: “How do PCIe bit error rates on lane 4 of PCIe port 5 on all units of Product-X during 2023 compare to 2024? Plot an average rate per week for 2023 and 2024, and put a vertical line everywhere the logs indicated a change in firmware, diagnostics tool revision, or BOM change. Give each of the mentioned change categories a unique color.”

The requester 102 may provide (e.g., via the computing device 108) one or more prompts 116 to the generative AI system 104 communicating the request 110 to the generative AI system 104. The prompt(s) 116 may have any format. For example, the prompt(s) 116 may be text written in natural language, a structured query (e.g., written in structured query language (SQL)), computer code, scripts, macros, audio data, image data, video data, symbolic data, and/or others.

The prompt(s) 116 may include text data having a format, such as Plain Text (TXT), Rich Text Format (RTF), Hypertext Markup Language (HTML), Extensible Markup Language (XML), JavaScript Object Notation (JSON), Comma-Separated Values (CSV), Markdown (MD), LaTeX (TEX), Portable Document Format (PDF), Microsoft Word Document (DOCX), ASCII, Portable Document Format (PDF), and/or others. The prompt(s) 116 may include audio data having a format, such as MPEG-1 Audio Layer III (MP3), Waveform Audio File Format (WAV), Advanced Audio Codec (AAC), Free Lossless Audio Codec (FLAC), Windows Media Audio (WMA), Ogg Vorbis (OGG), Apple Lossless Audio Codec (ALAC), Audio Interchange File Format (AIFF), Adaptive Multi-Rate (AMR), Opus, and/or others. The prompt(s) 116 may include image data having a format, such as Joint Photographic Experts Group (JPEG) format, Portable Network Graphics (PNG) format, Graphics Interchange Format (GIF), Bitmap (BMP) format, Tagged Image File Format (TIFF), Scalable Vector Graphics (SVG) format, Web Picture (WEBP) format, High Efficiency Image File Format (HEIF), Raw Image Format (RAW), Photoshop Document (PSD) format, PDF, and/or others. The prompt(s) 116 may include video data having a format, such as MPEG-4 Part 14 (MP4 ), Audio Video Interleave (AVI), QuickTime File Format (MOV), Windows Media Video (WMV), Flash Video Format (FLV), Matroska Video Format (MKV), Web Media (WEBM), Moving Picture Experts Group (MPEG), 3rd Generation Partnership Project (3GP), Advanced Video Coding High Definition (AVCHD), High Efficiency Video Coding (HEVC or H.265), Ogg Video (OGV), MPEG Transport Stream (MTS/M2TS), and/or others. In some embodiments, the prompt(s) 116 may include design data (e.g., computer aided design data, 2D design data, 3D design data, and/or other types of design data), universal scene descriptor data (USD)—such as OpenUSD data—such as for Metaverse or NVIDIA's OMNIVERSE applications—or other 3D content generation and orchestration systems, and/or other types of data.

The generative AI system 104 includes one or more AI models 118, such as neural network(s), LM(s), LLM(s), VLM(s), MMLM(s), SLM(s), and/or one or more other types of machine learning models. The generative AI system 104 obtains information from and/or related to the system 114 and uses the AI model(s) 118 to process the prompt(s) 116 and generate one or more answers 120. For example, in FIG. 1, the answer(s) 120 include a diagram 124 and information 126 (e.g., “Bit Error Rates are down 23% in 2024 compared to 2023”).

While processing the prompt(s) 116, the generative AI system 104 may generate one or more questions 130 requesting information from the requester 102. For example, in FIG. 1, the question(s) 130 include(s) text asking “Product-X has four different SKUs, do you want all SKUs represented or only SKU S201, S202, S220, or S221?” In response to the question(s) 130, the requester 102 may provide one or more responses 132. In response to the questions(s) 130, the requester 102 may provide a pointer to one or more other systems, where the pointer may include access credentials for the other system(s). For example, in FIG. 1, the response(s) 132 include(s) text responding, “All SKUs.” The generative AI system 104 may use the response(s) 132 to generate the answer(s) 120.

To process the prompt(s) 116 of FIG. 1, the generative AI system 104 may interpret the prompt(s) 116, and infer that the prompt(s) 116 refer to factory logs generated for “Product-X” in 2023 and 2024. The generative AI system 104 may obtain these logs and search them to contextually find data related to “bit error rates on lane 4 of port 5 on PCIE,” determine weekly averages, and/or plot the weekly averages. The generative AI system 104 may find (contextually) any indication in the factory logs (e.g., in one or more different folders and/or in one or more different files) describing changes in the listed categories that occurred, and plot those as well. The generative AI system 104 may respond to the prompt(s) 116 with the clarifying question(s) 130, such as the one illustrated in FIG. 1. By way of another non-limiting example, the clarifying question(s) 130 may include “there was a log format change it seems on Jun. 4, 2023, resulting in the enumeration of ports starting at 0 instead of 1, should we infer that data prior to June 4th you wish to see: a) data of port 5 prior to Jun. 4, 2023, and after of port 4 compared? b) data of port 5 prior to Jun. 4, 2023, and still port 5 as named after the transition in format? c) represent both in separate plots?” In this example, the log format change may be detected using the graph structure.

Instead of issuing the clarifying question(s) 130, the generative AI system 104 may act upon each of one or more possible choices to provide a quick response. An estimated token cost may be calculated for different options (e.g., for options a-c above) in accordance with the prompt(s) 116. For example, the prompt(s) 116 may specify that the generative AI system 104 is to “be as greedy as possible with resources to generate each path found,” and/or to “please prompt me with the top three branches from the seed query and let me determine whether or not to proceed with resource usage for each branch.” The estimated token cost(s) may allow the requester 102 and/or the generative AI system 104 to modify or scale compute and/or other resources based on, for example, other workloads, load balancing, number of users on a server cluster, power efficiency, energy efficiency, etc. The requester 102 may indicate that one or more jobs are to be performed at particular (e.g., optimal) times (e.g., when user counts are low, when memory utilization is low, at a prescribed time of day, etc.).

In the example above, if a difference in log format is detected, the generative AI system 104 may generate an automated ticket in a format that is common to the different log formats so that an anomaly found by the generative AI system 104, identified by the prompt(s) 116, and/or identified by the response(s) 132 may be tracked, for example, in the event the anomaly is corrected. The generative AI system 104 may prompt the requester 102 (e.g., using the clarifying question(s) 130) to indicate whether the anomaly (which may require less than optimal handholding of data processing) should be corrected. If the requester 102 indicates the anomaly should be corrected, the generative AI system 104 may automatically generate a work order and/or a ticket to address and/or correct the anomaly. If the generative AI system 104 determines data (e.g., log data) is erroneous and/or requires action, the generative AI system 104 may have already generated a ticket, and may ask the requester 102 (e.g., in the clarifying question(s) 130) whether to submit the ticket as a final action in a query/response loop. For example, in the example of PCIE errors, the clarifying question(s) 130 may include: “It seems that the data had a large change in July of 2023, should I file a NVBUG on this difference and request an action from the PCIE Working Group Lead to respond with next steps?” The generative AI system 104 could be used to provide failure analysis and/or improve yield.

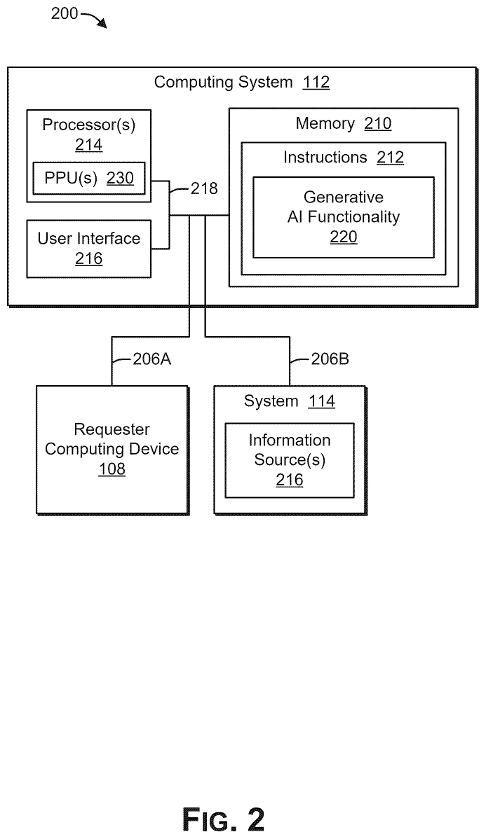

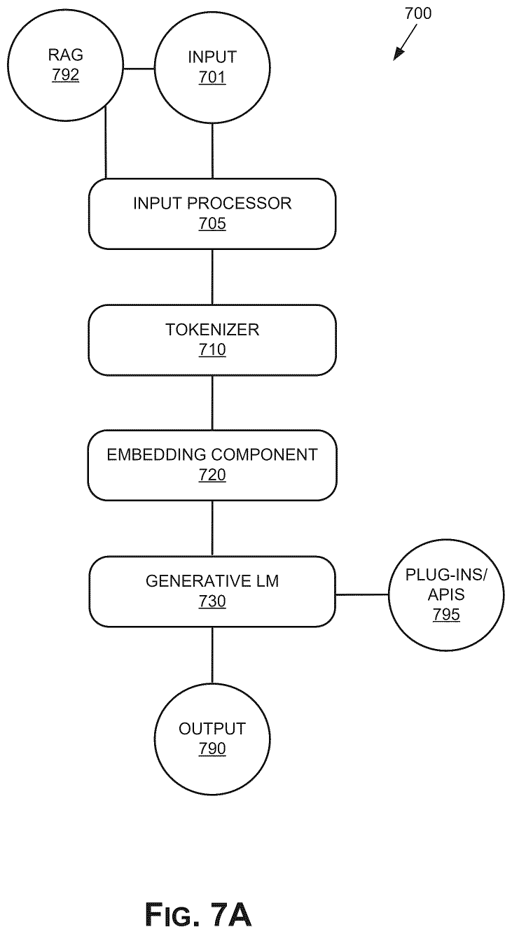

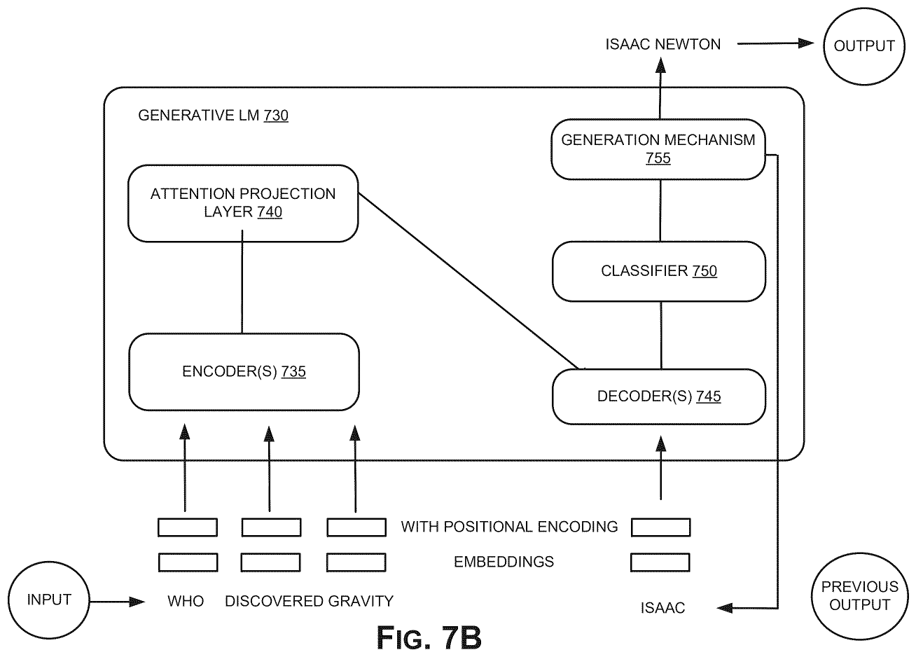

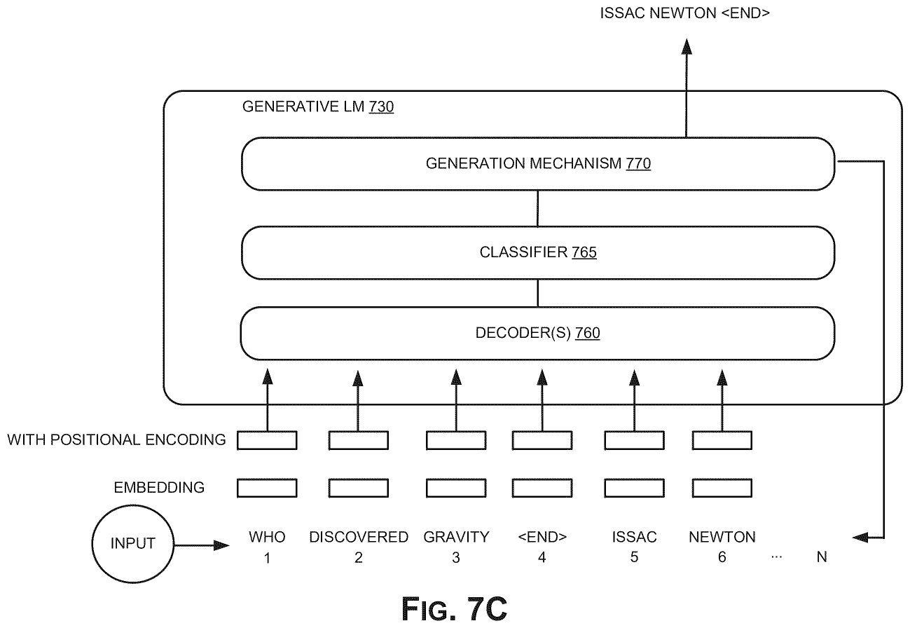

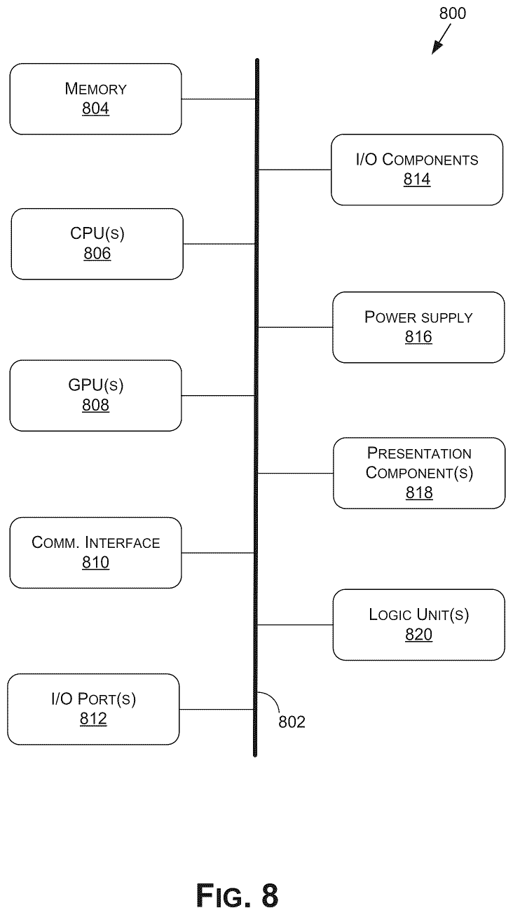

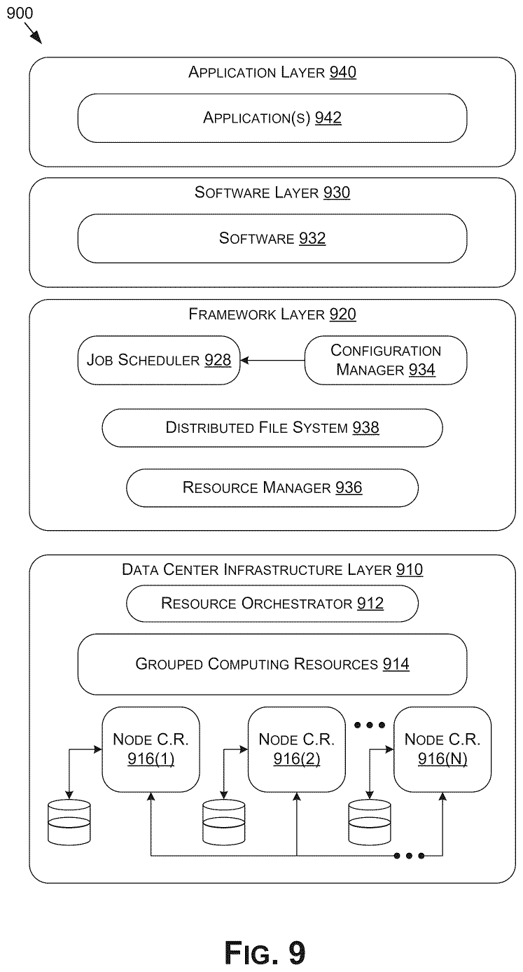

With reference to FIG. 2, FIG. 2 is an example system 200 implementing the generative AI system 104, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 7A-7C), one or more computing devices or components thereof (e.g., as described in FIG. 8), and/or one or more data centers or components thereof (e.g., as described in FIG. 9).

In at least one embodiment, the system 200 includes the computing system 112 in communication with the computing device 108 operated by the requester 102 and/or the system 114. In at least one embodiment, the computing system 112 may be a component of the computing device 108 and/or the system 114. In at least one embodiment, the computing device 108 and/or the system 114 may be component(s) of the computing system 112. In at least one embodiment, the computing system 112 may be connected to the computing device 108 by one or more wired and/or wireless communication links or connections 206A. In at least one embodiment, the computing system 112 may be connected to the system 114 by one or more wired and/or wireless communication links or connections 206B.

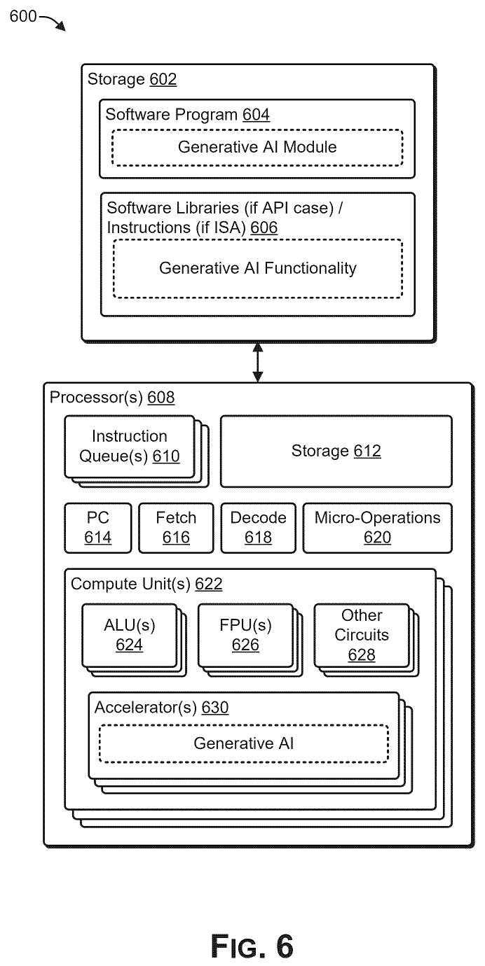

The computing device 108, the system 114, and/or the system 200 may perform various tasks in various environments, such as factories, healthcare facilities (e.g., hospitals), offices, households, vehicles, robots, warehouses, and/or any suitable context or environment. In at least one embodiment, at least a portion of the system 200 is implemented using at least a portion of any system(s) depicted in and/or described with respect to FIGS. 6-9. In at least one embodiment, at least a portion of the system 200 is used to implement at least a portion of any system(s) depicted in and/or described with respect to FIGS. 6-9. In at least one embodiment, at least a portion of the computing system 112 is implemented using at least a portion of any system(s) depicted in and/or described with respect to FIGS. 6-9. In at least one embodiment, at least a portion of the computing system 112 is used to implement at least a portion of any system(s) depicted in and/or described with respect to FIGS. 6-9. In at least one embodiment, at least a portion of at least one of the connection(s) 206A and 206B is implemented using at least a portion of any system(s) depicted in and/or described with respect to FIGS. 6-9. In at least one embodiment, at least a portion of at least one of the connection(s) 206A and 206B is used to implement at least a portion of any system(s) depicted in and/or described with respect to FIGS. 6-9.

In at least one embodiment, the computing system 112 may include memory 210, one or more processors 214, and a user interface 216. The memory 210 (e.g., one or more non-transitory processor-readable medium) may store processor executable instructions 212 that when executed by the processor(s) 214 implement generative AI functionality 220, and/or the like. By way of additional non-limiting examples, the memory 210 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). In at least one embodiment, at least a portion of the memory 210 is implemented using at least a portion of any system(s) depicted in and/or described with respect to FIGS. 6-9. In at least one embodiment, at least a portion of the memory 210 is used to implement at least a portion of any system(s) depicted in and/or described with respect to FIGS. 6-9.

The processor(s) 214 may include one or more circuits that perform at least a portion of the instructions 212 stored in the memory 210. The processor(s) 214 may include one or more parallel processing units (“PPU(s)”) 230, such as one or more graphics processing units (“GPU(s)”), one or more massively parallel GPU(s), and/or the like. In at least one embodiment, massively parallel GPU(s) refer to a collection of one or more GPUs, or any suitable processing units, which may be utilized to perform various processes in parallel. The processor(s) 214 may be implemented, for example, using a main central processing unit (“CPU”) complex, one or more microprocessors, one or more microcontrollers, the PPU(s) 230 (e.g., GPU(s)), one or more data processing units (“DPU(s)”), one or more arithmetic logic units (“ALU(s)”), and/or the like. In at least one embodiment, at least a portion of the processor(s) 214 is implemented using at least a portion of any system(s) depicted in and/or described with respect to FIGS. 6-9. In at least one embodiment, at least a portion of the processor(s) 214 is used to implement at least a portion of any system(s) depicted in and/or described with respect to FIGS. 6-9.

The user interface 216 may include a display device (not shown) that a user may use to view information generated and/or displayed by the computing system 112. The user may use the user interface 216 to enter user input into the computing system 112. The user interface 216 may communicate (e.g., wirelessly) with the computing device 108 and/or one or more other user devices (e.g., a cellular telephone, a laptop computer, a tablet, and/or the like) and may receive user input from the computing device 108 and/or the other user device(s). In at least one embodiment, at least a portion of the user interface 216 is implemented using at least a portion of any system(s) depicted in and/or described with respect to FIGS. 6-9. In at least one embodiment, at least a portion of the user interface 216 is used to implement at least a portion of any system(s) depicted in and/or described with respect to FIGS. 6-9.

In at least one embodiment, the computing system 112 includes or is connected to image capture device(s) that may be implemented using image capture device(s), LIDAR device(s), camera(s), video camera(s), depth video camera(s), and/or the like. The image capture device(s) may be positioned to capture images (e.g., 3D point clouds and/or 2D images) of one or more scenes. By way of a non-limiting example, the image capture device(s) may capture red, green, blue-depth (“RGB-D”) image data. In embodiments in which the scene(s) include a virtual scene, the image capture device(s) may include virtual video capture device(s). The image capture device(s) may capture one or more images included in the prompt(s) 116. The image capture device(s) may store images to the memory 210. The instruction 212, if executed by the processor(s) 214, may cause the processor(s) 214 to process the image(s) for use by the generative AI functionality 220. In at least one embodiment, at least a portion of the image capture device(s) is implemented using at least a portion of any system(s) depicted in and/or described with respect to FIGS. 6-9. In at least one embodiment, at least a portion of the image capture device(s) is used to implement at least a portion of any system(s) depicted in and/or described with respect to FIGS. 6-9.

The processor(s) 214, the user interface 216, and/or the memory 210 may communicate with one other over one or more connections 218, such as a bus, a Peripheral Component Interconnect Express (“PCIe”) connection (or bus), and/or the like. In at least one embodiment, at least a portion of the connection(s) 218 is implemented using at least a portion of any system(s) depicted in and/or described with respect to FIGS. 6-9. In at least one embodiment, at least a portion of the connection(s) 218 is used to implement at least a portion of any system(s) depicted in and/or described with respect to FIGS. 6-9.

The computing device 108 may be implemented as a cellular telephone, a laptop computer, a tablet, and/or the like. The system 114 may be implemented as a computing device and/or a computing system, such as a data center, a cloud computing system, and/or others. The computing device 108 and/or the system 114 may have one or more processors, such those described herein, to perform processor executable instructions. The computing device 108 and/or the system 114 may have memory, such that described herein, including, but not limited to non-transitory machine readable media to store instructions that are executable by the processor(s). The computing device 108 and/or the system 114 may have a user interface, including the user interface components, such those described herein. In at least one embodiment, the computing device 108 and/or the system 114 is/are implemented using at least a portion of any system(s) depicted in and/or described with respect to FIGS. 6-9. In at least one embodiment, the computing device 108 and/or the system 114 is/are used to implement at least a portion of any system(s) depicted in and/or described with respect to FIGS. 6-9.

The generative AI functionality 220 (e.g., performed by the processor(s) 214) implements at least a portion of the generative AI system 104. The generative AI functionality 220 implements and/or has access to the AI model(s) 118. The generative AI functionality 220 may obtain the prompt(s) 116 and use the AI model(s) 118 to generate the clarifying question(s) 130, obtain the response(s) 132, and/or provide the answer(s) 120. The generative AI functionality 220 may access the system 114 to obtain data related to the system 114, and/or otherwise access data related to the system 114. The generative AI functionality 220 may use such data to generate the answer(s) 120, and/or cause one or more corrective actions to be performed (e.g., issuance of ticket(s)). The generative AI functionality 220 may estimate costs associated with performing one or more different actions, and may ask the requester 102 (e.g., in one of the clarifying question(s) 130) which of the actions the requester 102 would like the generative AI functionality 220 to perform or cause to be performed. For example, the generative AI functionality 220 may determine costs associated with each of a plurality of requests included in the prompt(s) 116, and may ask the requester 102 if the requester 102 would like the generative AI functionality 220 to move forward with processing each request before doing so. By way of another non-limiting example, the generative AI functionality 220 may determine that a particular request could be responded in multiple different ways. When this occurs, the generative AI functionality 220 may prepare cost estimates associated with each of the ways, and may ask the requester 102 with which of the ways the requester 102 would like the generative AI functionality 220 to process the request before doing so.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications - such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. By way of a non-limiting example, at least a portion of the generative AI functionality 220 may be implemented as one or more microservices, and/or using one or more microservices. By way of another non-limiting example, one or more microservices may be used to implement at least a portion of the generative AI system 104, such as the AI model(s) 118, and/or one or more other components, such as those described herein.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs. By way of a non-limiting example, a kiosk, tablet, smart display, or other device may be the requester 102 and/or used by the requester 102 to provide information (e.g., the prompt(s) 116 and/or the response(s) 132) to the generative AI system 104. By way of another non-limiting example, one or more of such devices may be used to implement at least a portion of the generative AI system 104, and/or to implement at least a portion of the generative AI functionality 220.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. By way of a non-limiting example, a gaming application may be the requester 102 and/or used by the requester 102 to provide information (e.g., the prompt(s) 116 and/or the response(s) 132) to the generative AI system 104.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used. By way of a non-limiting example, a video conferencing application may be the requester 102 and/or used by the requester 102 to provide information (e.g., the prompt(s) 116 and/or the response(s) 132) to the generative AI system 104.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). By way of a non-limiting example, a robotics application may be the requester 102 and/or used by the requester 102 to provide information (e.g., the prompt(s) 116 and/or the response(s) 132) to the generative AI system 104. By way of another non-limiting example, the robotics application may be used to implement at least a portion of the generative AI system 104, and/or to implement at least a portion of the generative AI functionality 220.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. By way of a non-limiting example, an IVI system and/or an IX application may be the requester 102 and/or used by the requester 102 to provide information (e.g., the prompt(s) 116 and/or the response(s) 132) to the generative AI system 104. By way of another non-limiting example, the IVI system and/or the IX application may be used to implement at least a portion of the generative AI system 104, and/or to implement at least a portion of the generative AI functionality 220.

Although examples may be described herein with respect to using machine learning models, such as neural networks, this is not intended to be limiting. For example, and without limitation, any of the various machine learning models and/or neural networks described herein (e.g., with respect to the AI model(s) 118) may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

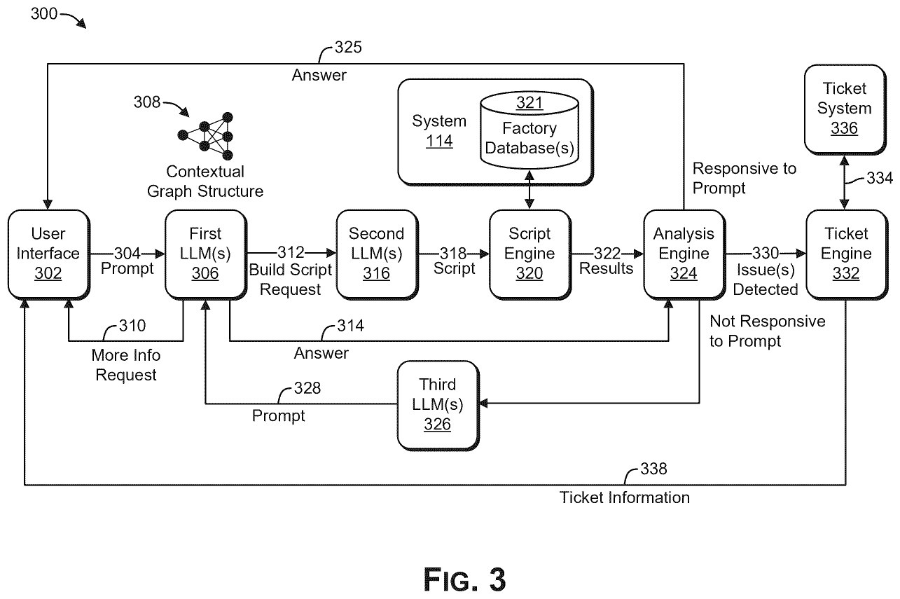

FIG. 3 is a block diagram illustrating example components 300 of the generative AI system 104 (see FIG. 1), in accordance with some embodiments of the present disclosure. As mentioned above, the generative AI system 104 may be implemented at least in part by the generative AI functionality 220 (e.g., performed by the processor(s) 214).

As shown in FIG. 3, the generative AI system 104 may include a user interface 302 for receiving information (e.g., a prompt 304) from the requester 102 (see FIG. 1), and/or displaying information (e.g., questions, answers, etc.) to the requester 102. The user interface 302 may be implemented at least in part by the generative AI functionality 220 (see FIG. 2). For example, the generative AI functionality 220 may include instructions that when executed by the processor(s) 214, cause the processor(s) 214 to instruct the computing device 108 to display user interface components on a display device (e.g., a monitor, touchscreen, and/or other display device) of the computing device 108. The user interface components may display information and/or receive input from the requester 102 via a user input device (e.g., a touchscreen, keyboard, mouse, and/or other input device) of the computing device 108. The computing device 108 may transmit (e.g., over the connection(s) 206A) that user input or information based at least on the user input to the user interface 302 implemented at least in part by the generative AI functionality 220 (which is implement by the computing system 112). For example, the requester 102 may use the computing device 108 to provide the prompt 304 to the user interface 302 of the generative AI system 104.

The generative AI system 104 receives the prompt 304 supplied by the requester 102 via the user interface 302, and the generative AI functionality 220 provides the prompt 304 to one or more first LLMs 306. The AI model(s) 118 (see FIG. 1) of the generative AI system 104 include the first LLM(s) 306. The generative AI functionality 220 may train the first LLM(s) 306 using data related to the system 114. For example, the generative AI functionality 220 may train the first LLM(s) 306 using the structure (e.g., architecture) of one or more products, definition(s) of product(s), a factory flow process used to manufacture the product(s) (e.g., what happens to each of the product(s) at each stage of manufacturing and test), type(s) of diagnostic information available (e.g., structure of diagnostic log) with respect to the product(s), and/or any other available data related to the product(s) and/or manufacturing process.

The first LLM(s) 306 may implement and/or use a contextual graph structure 308, which may increase a probability that the first LLM(s) 306 generate(s) a correct response. For example, the contextual graph structure 308 may include nodes, and edges that represent relationships and/or interactions between the nodes. By way of non-limiting examples, the nodes of the contextual graph structure 308 may represent one or more user queries, one or more database schemas, available data, one or more potential scripts, one or more expected outcomes, one or more aspects of the structure (e.g., architecture) of one or more products, one or more aspects of a factory flow process used to manufacture the product(s) (e.g., what happens to each of the product(s) at each stage of manufacturing and test), one or more aspects of the type(s) of diagnostic information available (e.g., structure of diagnostic log) with respect to the product(s), and/or any other available data related to the product(s) and/or manufacturing process. The edges may be weighted to provide additional context about strengths of the relationships.

The contextual graph structure 308 represents data in a manner that captures relationships and interactions between the nodes within a specific context. The context can include additional information such as time, location, specific conditions under which the interactions occur, and/or one or more others. The contextual graph structure 308 may use context to understand not only static connections (or the edges) but how these connections might change or behave under different circumstances (or in different context). The contextual graph structure 308 may model the system 114 and/or one or more portions of the system 114 and use context to understand dynamics and/or connections between the nodes. Contextual graphs may be particularly useful in scenarios where the same entities might have different relationships depending on the context, such as may be the case in the system 114.

The first LLM(s) 306 may implement or cause to be implemented one or more techniques, such as node2vec, GraphSAGE, one or more Graph Neural Networks (GNNs), and/or one or more others, that generate embeddings for data stored in the contextual graph structure 308. These embeddings may capture structural and contextual information of the nodes, and the edges included in the contextual graph structure 308. The embeddings may be input into the first LLM(s) 306. For example, the first LLM(s) 306 may be combined with one or more GNNs to process data stored in the contextual graph structure 308. The GNN(s) may learn the embeddings from the contextual graph structure 308, and the first LLM(s) 306 may process these embedding and the prompt 304 (e.g., textual and/or sequential data). This combination allows the first LLM(s) 306 to leverage both the relational information stored in the contextual graph structure 308, and the semantic understanding embodied in the first LLM(s) 306. The first LLM(s) 306 may include one or more attention mechanisms or layers that focus on relevant parts of the contextual graph structure 308, allowing the first LLM(s) 306 to weigh different nodes and edges based on their importance in a given context. The techniques may encode contextual information obtained from the contextual graph structure 308 as one or more features and/or one or more tokens, and provide the feature(s) and/or token(s) to the first LLM(s) 306 (e.g., in an input sequence).

The first LLM(s) 306 may use the contextual graph structure 308 to perform one or more tasks. For example, the first LLM(s) 306 may analyze the prompt 304 and generate (1) a request 310 for more information from the requester 102, (2) a request 312 to build a script to obtain more information, and/or (3) an answer 314. In such embodiments, the first LLM(s) 306 may use the contextual graph structure 308 to determine which of the aforementioned outputs to generate. For example, the first LLM(s) 306 may use the contextual graph structure 308 to estimate costs for creating a tool (item (2) above) and/or generating an answer (item (3) above). Further, if more than one option or branch exists for creating a tool or generating an answer, the first LLM(s) 306 may use the contextual graph structure 308 to predict a token cost to execute each of the branched paths. The tokens may represent a value of time and/or compute resources (power, memory, time, etc.) required for each potential generative path. The generative AI functionality 220 may cause the user interface 302 to display the estimated costs along with at least one clarifying question (e.g., one of the clarifying question(s) 130) to the requester 102 asking the requester 102 to select one or more of the branches to perform. After the requester 102 responds via the user interface 302, the generative AI functionality 220 may cause the selected branch(es) to be performed.

In some embodiments, a query included in the prompt 304 directs the generative AI functionality 220 with respect to which branches to perform. For example, the prompt 304 may instruct the generative AI functionality 220 to perform all of the branches to provide a quick answer. By way of another non-limiting example, the prompt 304 may specify that the generative AI system 104 is to prompt the requester 102 regarding only a predetermined number of the top branches (e.g., branches ranked at the top by the ranker, such as branches most likely to generate a correct answer, branches with the lowest cost, and/or branches having one or more other desired qualities) so that the requester 102 may select which of those branches the generative AI functionality 220 is to cause to be performed. The estimated token cost(s) may allow the requester 102 and/or the generative AI functionality 220 to modify or scale compute and/or other resources based on, for example, other workloads, load balancing, number of users on a server cluster, power efficiency, energy efficiency, etc. The prompt 304 and/or the requester 102 may indicate that one or more branches and/or one or more jobs within one or more of the branches are to be performed at particular (e.g., optimal) times (e.g., when user counts are low, when memory utilization is low, at a prescribed time of day, etc.).

The first LLM(s) 306 may use the contextual graph structure 308 to improve a probability of a correct interpretation of a query included in the prompt 304 based on data context and/or previous similar queries. The first LLM(s) 306 may use the contextual graph structure 308 to support the ranker and/or to improve a probability that the generative AI system 104 will generate an answer that is responsive to the prompt 304, and/or any other prompts provided to the generative AI system 104. The first LLM(s) 306 may use the contextual graph structure 308 to detect a change in the data represented by the contextual graph structure 308. For example, the first LLM(s) 306 may use the contextual graph structure 308 to detect a change in a log format.

As mentioned herein, the first LLM(s) 306 may analyze the prompt 304 and generate (1) the request 310 for more information from the requester 102, (2) the request 312 to build a script to obtain more information, and/or (3) the answer 314. If the first LLM(s) 306 generated the request 310 for more information from the requester 102, the generative AI functionality 220 forwards the request 310 to the user interface 302, which provides (e.g., displays) the request to the requester 102. The requester 102 may then enter another prompt via the user interface 302, and the generative AI functionality 220 may supply this prompt to the first LLM(s) 306. In this manner, the generative AI functionality 220 may interact with the requester 102 that provided the prompt 304. For example, the first LLM(s) 306 may generate follow up questions if a request included in the prompt 304 is unclear or additional (e.g., background) information is needed to clarify the contextual meaning of at least a portion of the prompt 304.

If the first LLM(s) 306 generated the request 312 to build a script, the generative AI functionality 220 may forward the request 312 to one or more second LLMs 316. The AI model(s) 118 (see FIG. 1) of the generative AI system 104 may include the second LLM(s) 316. The generative AI functionality 220 may train the second LLM(s) 316 using one or more scripting languages (e.g., Python), information describing data available to query, etc. The second LLM(s) 316 may generate a script 318 to obtain the data (e.g., from one or more factory databases 321) requested by the request 312.

The generative AI functionality 220 forwards the script 318 generated by the second LLM(s) 316 to a script engine 320, which executes the script 318 and obtains results 322. The script engine 320 may be a component of or accessible by the generative AI system 104. The script 318 may include one or more queries (e.g., prepared using structured query language (SQL) or another suitable language and/or format). The script engine 320 may execute the query(ies) against one or more factory databases 321 and/or other data repositories. For example, the script 318 may include one or more queries to query diagnostic logs generated by tests that test the functionality of one or more products, devices, methods, systems, and/or other testable subject matter.

The generative AI functionality 220 forwards the results 322 obtained by performing the script 318 to an analysis engine 324. The analysis engine 324 may be a component of or accessible by the generative AI system 104. If the first LLM(s) 306 generated the answer 314, the generative AI functionality 220 forwards the answer 314 to the analysis engine 324.

The analysis engine 324 receives the results 322 generated by the script engine 320 and/or the answer 314 generated by the first LLM(s) 306. The results 322 and/or the answer 314 will be referred to as potential answer(s). The analysis engine 324 may perform further operations on the potential answer(s) (e.g., combine the potential answer(s) with additional data). Then, the analysis engine 324 determines whether the potential answer(s) is/are responsive to the prompt 304 and/or any additional prompt(s) provided to the generative AI system 104 (e.g., in the response(s) 132). For example, the analysis engine 324 may include one or more neural networks (trained with appropriate contextual information) to predict a probability that the potential answer(s) is/are responsive to the prompt 304 and/or the additional prompt(s). In such embodiments, the AI model(s) 118 (see FIG. 1) of the generative AI system 104 include(s) the neural network(s) that predict the probability that the potential answer(s) is/are responsive. If the analysis engine 324 determines the potential answer(s) is/are responsive to the prompt 304 and/or the additional prompt(s) (e.g., the probability is greater than a threshold value), the generative AI functionality 220 forwards the potential answer(s), as an answer 325, to the user interface 302, for example, to be displayed to the requester 102.

On the other hand, if the analysis engine 324 determines the potential answer(s) is/are not responsive to the prompt 304 and/or the additional prompt(s) (e.g., the probability is not greater than the threshold value), the analysis engine 324 provides the prompt 304 and/or the additional prompt(s), as well as the potential answer(s) to one or more third LLMs 326 to generate one or more new prompts 328 requesting additional information. The AI model(s) 118 (see FIG. 1) of the generative AI system 104 may include the third LLM(s) 326. Then, the generative AI functionality 220 provides the new prompt(s) 328 to the first LLM(s) 306, which processes the new prompt(s) 328 as described above. For example, the first LLM(s) 306 may generate (1) a new request (e.g., like the request 310) for more information from the user, (2) a new request (e.g., like the request 312) to build a script to obtain more information, and/or (3) a new answer (e.g., like the answer 314). Then, the generative AI functionality 220 provides the new prompt(s) 328 to the first LLM(s) 306, which process(es) the new prompt(s) 328 as described above.

The analysis engine 324 may determine whether the potential answer(s) is/are indicative of any issues (e.g., anomalies) for which one or more corrective actions may be taken. For example, the analysis engine 324 may include one or more neural networks that use the potential answer(s) to predict a probability that an issue exists. In such embodiments, the AI model(s) 118 (see FIG. 1) of the generative AI system 104 include(s) the neural network(s) that predict the probability that an issue exists. If the analysis engine 324 determines one or more issues exist (e.g., the probability that each of the issue(s) exists is greater than a threshold value), the generative AI functionality 220 may ask the requester 102 whether to take any actions, and/or forward information 330 related to the issue(s) to a ticket engine 332 (e.g., other software tools or infrastructure). If the generative AI functionality 220 asks the requester 102 whether to take any actions, the generative AI functionality 220 may generate estimate(s) of cost associated with taking the action(s), generate a question (e.g., one of the clarifying question(s) 130) including the cost estimate(s) and asking the requester 102 whether to take the action(s), and forward the clarifying question to the user interface 302, which provides (e.g., displays) the request to the requester 102. If the requester 102 responds (via the user interface 302) that the action(s) are to be taken, the generative AI functionality 220 may forward the information 330 related to the issue(s) to the ticket engine 332 (e.g., other software tools or infrastructure).

The ticket engine 332 may automatically generate one or more tickets 334 to correct the issue(s) and provide the ticket(s) 334 to a ticket system 336, such as a project management system (e.g., JIRA). Then, the ticket engine 332 and/or the ticket system 336 may forward ticket information 338 to the user interface 302 for example, to display to the requester 102. The ticket engine 332 and/or the ticket system 336 may be a component of or accessible by the generative AI system 104.

At any point, the generative AI functionality 220 may send updates to the user interface 302, for example, to display to the requester 102. The requester 102 may use information included in such updates to provide one or more prompts to the first LLM(s) 306 to help guide the generative AI functionality 220. The generative AI functionality 220 may analyze costs, including power, memory, and/or time, of various paths to process a prompt, and then determine a best path based on cost, and/or provide choices to the requester 102. One or more of the neural networks implemented and/or used by the generative AI functionality 220 may be trained on data that the neural network(s) is/are to analyze, such as factory failure logs, diagnostic logs, and/or other data.

The generative AI system 104 may include the processor(s) 214, which may perform first neural network(s) (e.g., the first LLM(s) 306). The first neural network(s) may use a first prompt (e.g., the prompt 304) to generate output that includes at least one of a first answer (e.g., the answer 314), a request (e.g., the request 310) for information, or a request (e.g., the request 312) to build a tool (e.g., the script 318) to obtain data. In at least one embodiment, the first neural network(s) are be trained using information related to manufacture of one or more products. If the output includes the request (e.g., the request 312) to build the tool, the processor(s) 214 may perform second neural network(s) (e.g., the second LLM(s) 316) that use the request to generate the tool (e.g., the script 318). In at least one embodiment, the second neural network(s) are be trained using information related to generating tools, such as scripts, to obtain the data. The processor(s) 214 may cause the tool (e.g., the script 318) to obtain a result (e.g., the results 322). In at least one embodiment, the tool includes at least one script, and the processor(s) 214 perform the script(s) and/or cause the script(s) to be performed to obtain the result. The processor(s) 214 may perform third neural network(s) (e.g., of the analysis engine 324) to determine whether potential answer(s) based at least on the result (e.g., the results 322) and/or the first answer (e.g., the answer 314) is/are responsive to the first prompt (e.g., the prompt 304). The processor(s) 214 may perform fourth neural network(s) (e.g., the third LLM(s) 326) that generate a second prompt (e.g., the new prompt(s) 328) to be used by the first neural network(s) if the potential answer(s) is/are determined not to be responsive to the first prompt (e.g., the prompt 304). The processor(s) 214 may use a user interface (e.g., the user interface 302) to present the request (e.g., the request 310) for the information from the requester (e.g., the requester 102) and/or receive a response from the requester, if the output includes the request for the information.

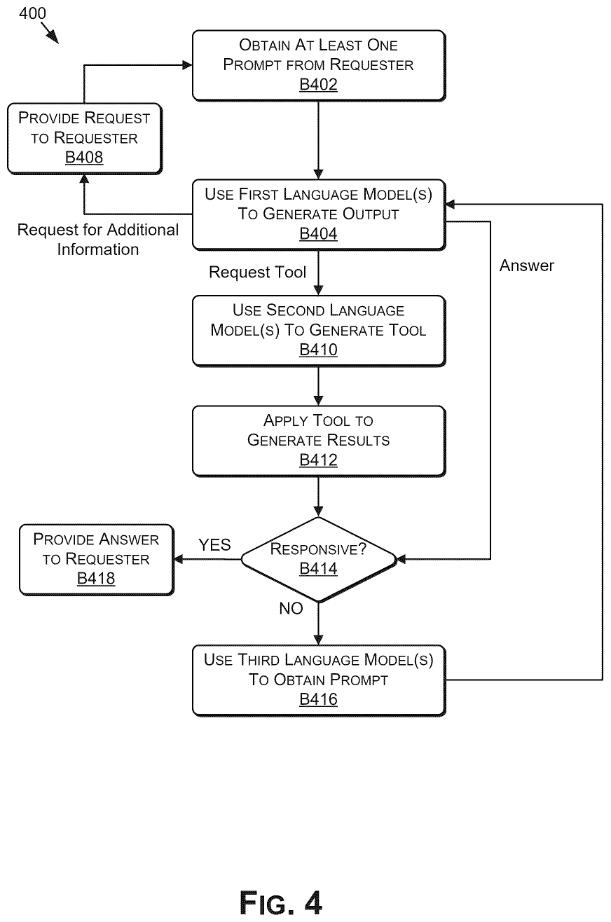

Now referring to FIG. 4, each block of a method 400, described herein, comprises a computing process that may be performed using any combination of hardware, firmware, and/or software. For instance, various functions may be carried out using one or more processors executing instructions stored in one or more memories. The method 400 may also be embodied as computer-usable instructions stored on computer storage media. The method 400 may be provided by a standalone application, a service or hosted service (standalone or in combination with another hosted service), as a microservice via an application programming interface (API) or a plug-in to another product, to name a few. In addition, the method 400 is described, by way of example, with respect to the system of FIG. 1. However, this method 400 may additionally or alternatively be executed by any one system, or any combination of systems, including, but not limited to, those described herein. By way of a non-limiting example, the generative AI functionality 220 (e.g., performed by the processor(s) 214) may perform at least a portion of the method 400.

FIG. 4 is a flow diagram showing the method 400 for using the generative AI system 104 to obtain a response (e.g., the answer(s) 120) to a request (e.g., the request 110), in accordance with some embodiments of the present disclosure. The method 400, at block B402, includes obtaining at least one prompt (e.g., the prompt(s) 116) from the requester 102. At block B404, the method 400 includes using one or more first language models (e.g., the first LLM(s) 306) to generate output. If the output includes a request (e.g., the request 310) for additional information from the requester 102, the method 400, at block B408, includes providing the request to the requester 102. The requester 102 may respond to the request generated at block B404 by inputting one or more new prompts into the generative AI system 104, and the method 400, may return to block B402 to obtain the new prompt(s).

If the output generated at block B404 includes a request for a tool (e.g., the request 312 for the script 318), the method 400, at block B410, includes inputting the request into one or more second language models (e.g., the second LLM(s) 316) to generate the tool (e.g., the script 318). The method 400, at block B412, includes applying or using the tool generated at block B410 to generate results (e.g., the results 322). For example, the method 400, at block B412, may include using the script engine 320 to apply the tool (e.g., perform the script 318). The tool may include one or more queries and/or one or more database procedures that when performed obtain information from the system 114, for example, from the factory database(s) 321. After block B412, the method 400, at block B414, includes analyzing the results generated at block B412 to determine whether the results are responsive to the prompt(s) obtained at block B402.

If the output generated at block B404 includes an answer (e.g., the answer 314), the method 400, at decision block B414, includes analyzing that answer to determine whether the answer is responsive to the prompt(s) obtained at block B402. In this example, the answer (e.g., the answer 314) generated at the block B404 and/or the results (e.g., the results 322) generated at the block B412 are referred to as potential answer(s). By way of a non-limiting example, block B414 may be performed by the analysis engine 324 (see FIG. 3). The method 400, at decision block B414, includes analyzing the potential answer(s) to determine if the potential answer(s) are responsive to the prompt(s) obtained at block B402. By way of a non-limiting example, this analysis may be performed at least in part using one or more neural networks. The prompt(s) obtained at block B402 may include the initial prompt (e.g., the prompt 304) and/or any additional prompts, for example, provided by the requester 102, for example, in response to requests (e.g., the request 310) for additional information. In at least one embodiment, one or more automated processes, such as those of the generative AI system 104 itself (e.g., by the third LLM(s) 326, and/or a different portion of the generative AI system 104), and/or another system, such as any of those described herein, may generate one or more of these additional prompts. The decision at decision block B414 is “YES,” when the potential answer(s) are responsive to the prompt(s) obtained at block B402. Otherwise, the decision at decision block B414 is “NO.”

If the decision at decision block B414 is “NO,” the method 400, at block B416, includes providing the potential answer(s) to one or more third language models (the third LLM(s) 326) to generate one or more new prompts (e.g., the new prompt(s) 328). Then, the method 400 may include providing the new prompt(s) (e.g., the new prompt(s) 328) to the first language model(s) (the first LLM(s) 306).

If the decision at decision block B414 is “YES,” the method 400, at block B418, includes providing the potential answer(s) to the requester as an answer or response (e.g., the answer 325) to the prompt(s) obtained by the generative AI system 104 at block B402. The method 400 may terminate after block B418.

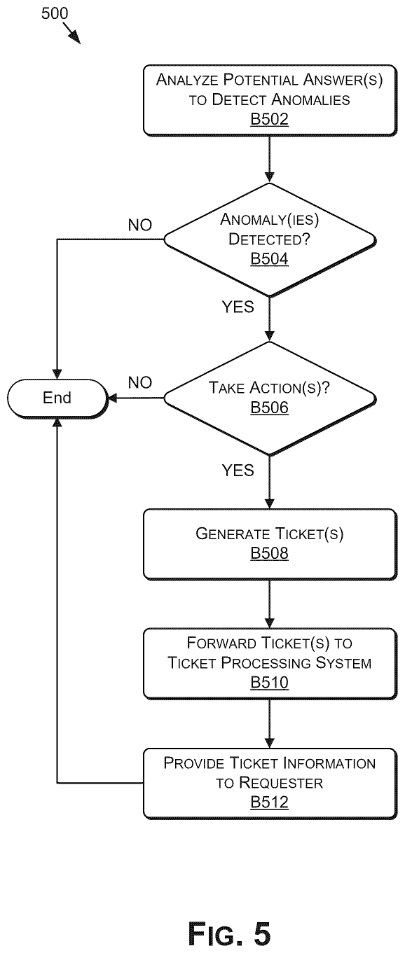

Now referring to FIG. 5, each block of a method 500, described herein, comprises a computing process that may be performed using any combination of hardware, firmware, and/or software. For instance, various functions may be carried out using one or more processors executing instructions stored in one or more memories. The method 500 may also be embodied as computer-usable instructions stored on computer storage media. The method 500 may be provided by a standalone application, a service or hosted service (standalone or in combination with another hosted service), as a microservice via an application programming interface (API) or a plug-in to another product, to name a few. In addition, the method 500 is described, by way of example, with respect to the system of FIG. 1. However, this method 500 may additionally or alternatively be executed by any one system, or any combination of systems, including, but not limited to, those described herein. By way of a non-limiting example, the generative AI functionality 220 (e.g., performed by the processor(s) 214) may perform at least a portion of the method 500.

FIG. 5 is a flow diagram showing the method 500 for using the generative AI system 104 to detect one or more anomalies, and cause tickets to be generated for the anomaly(ies), in accordance with some embodiments of the present disclosure. The method 500 may be performed after blocks B404 and/or B412 of the method 400 (see FIG. 4). In this example, the answer (e.g., the answer 314) generated at the block B404 and/or the results (e.g., the results 322) generated at the block B412 are referred to as potential answer(s), and were generated before block B502 of the method 500. By way of a non-limiting example, blocks B502-B506 may be performed by the analysis engine 324 (see FIG. 3).

The method 500, at block B502, includes analyzing the potential answer(s) for any anomalies the potential answer(s) might include. By way of a non-limiting example, this analysis may be performed at least in part using one or more neural networks.

The method 500, at decision block B504, includes determining whether any anomalies were detected in block B502. The decision in decision block B504 is “YES,” when anomalies were detected in block B502. Otherwise, the decision in decision block B504 is “NO.” When the decision in decision block B504 is “NO,” the method 500 may include returning to block B502 to analyze other potential answer(s) or the method 500 may terminate.

When the decision in decision block B504 is “YES,” the method 500, at decision block B506, includes deciding whether to take one or more actions with respect to the anomaly(ies) detected in block B502. The decision in decision block B506 is “YES,” when the method 500 (e.g., the generative AI functionality 220 performing the method 500) decides to take action(s) with respect to the anomaly(ies). Otherwise, the decision in decision block B506 is “NO.” At decision block B506, the method 500 may include generating cost estimate(s) for performing the action(s), presenting the cost estimate(s) to the requester 102 along with question(s) as to which of the action(s) is/are to be taken, and evaluating one or more responses to the question(s).

When the decision in decision block B506 is “NO,” the method 500 may include returning to block B502 to analyze other potential answer(s) or the method 500 may terminate. On the other hand, when the decision in decision block B506 is “YES,” the method 500, at block B508, generates one or more tickets to address the anomaly(ies) detected in block B502. By way of a non-limiting example, the method 500 may include using the ticket engine 332 to generate the ticket(s). The method 500, at block B510, includes forwarding the ticket(s) to a ticket processing system (e.g., the ticket system 336) to be processed thereby. The method 500, at block B512, includes providing ticket information to the requester 102. The ticket information may identify the anomaly(ies) detected in block B502, and/or may include an indication that the ticket(s) have been forwarded to the ticket processing system (e.g., the ticket system 336) for processing. After block B512, the method 500 may include returning to block B502 to analyze other potential answer(s) or the method 500 may terminate.

FIG. 6 illustrates an example of a system 600 that can include software and hardware to implement a generative AI to generate information related to a system (e.g., a manufacturing system), perform one or more neural networks (e.g., one or more language models) that implement the generative AI, and/or otherwise perform any of the operations described herein, according to at least one embodiment. System 600 can include storage 602 and processor(s) 608. Storage 602 can include, for example, memory, cache, or other storage described further herein. Storage 602 can be separate from processor(s) 608, or storage 602 can be included in processor(s) 608 (e.g., in storage 612). In at least one embodiment, software program 604 and/or software libraries (or instructions) 606 can be stored in memory, cache, or other storage and provided to processor(s) 608 to cause one or more circuits of processor(s) 608 to perform operations described herein. In at least one embodiment, software program 604 and/or software libraries (or instructions) 606 can be integrated into one or more circuits of processor(s) 608. Software program 604, which can be used to perform any of the operations described herein, may be stored on storage 602.

In at least one embodiment, software program 604 can include one or more software modules. For example, the software module(s) may include a generative AI module to implement the generative AI functionality 220.

In at least one embodiment, as used in any implementation described herein, unless otherwise clear from context or stated explicitly to contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof including those further described herein.

In at least one embodiment, software program 604 can include a collection of software code, commands, instructions, or other sequences of text to instruct a computing device to perform one or more computational operations and/or invoke one or more other sets of instructions, such as API(s) or API function(s) or Instruction Set Architecture (ISA) level instructions, to be executed or otherwise performed. The ISA may include or implement at least a portion of the generative AI functionality 220. Instructions (e.g., hardware instructions) or microcode can involve ISA level instructions, which can include native ISA instructions or non-native ISA instructions. Software program 604 and/or software libraries (or instructions) 606 (e.g., one or more modules) can be distributed among multiple processors that communicate over a bus, network, by writing to shared memory, and/or any suitable communication process such as those described herein.

In at least one embodiment, system 600 can include one or more software libraries 606 that can, for example, provide one or more APIs and/or ISA instructions. In at least one embodiment, one or more APIs and/or ISA instructions can be used to implement a generative AI to generate information related to a system (e.g., a manufacturing system), perform one or more neural networks (e.g., one or more language models) that implement the generative AI, and/or perform one or more other operations such as those described herein. In at least one embodiment, one or more software libraries 606 can be included in drivers and/or runtimes. In at least one embodiment, software libraries 606 (e.g., including one or more APIs and/or ISA instructions) can include sets of software instructions that, if executed or otherwise performed, cause processor(s) 608 to perform one or more computational operations, such as any of the operations described herein. In at least one embodiment, one or more APIs and/or ISA instructions can be distributed or otherwise provided as a part of one or more software libraries 606, runtimes, drivers, and/or any other grouping of software and/or executable code further described herein. In at least one embodiment, one or more APIs and/or ISA instructions can perform one or more computational operations in response to invocation by software program 604.

Processor(s) 608 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in or discussed with respect to FIGS. 7A-9. In at least one embodiment, processor(s) 608 can retrieve or fetch instructions (e.g., one or more APIs and/or ISA instructions) from storage 602 using, for example, instruction fetch 616 (e.g., for an Instruction Fetch stage). Instructions can include instructions to implement a generative AI to generate information related to a system (e.g., a manufacturing system), perform one or more neural networks (e.g., one or more language models) that implement the generative AI, and/or perform one or more other operations such as those described herein. In at least one embodiment, processor(s) 608 can include storage 612 and instruction queue 610 to store and queue instructions fetched from storage 602. In at least one embodiment, fetched instructions can be decoded by decode 618 to determine what operation should be performed by processor(s) 608 (e.g., in an Instruction Decode stage). In at least one embodiment, processor(s) 608 can fetch additional operands (data) that may be used for instructions, and operands can be stored, e.g., in registers or storage 612. In at least one embodiment, micro-operations 620 can perform operations on data stored in one or more registers or storage 612. For example, each step of instructions fetched by processor(s) 608 can be decomposed during execution so processor(s) 608 can execute instructions in steps through a series of micro-operations 620. In at least one embodiment, program counter (PC) 614 can hold an address for a next instruction and can be updated to point to the next instruction to be executed by processor(s) 608.

In at least one embodiment, processor(s) 608 can perform instructions (e.g., in an Execution stage). For example, processor(s) 608 can perform an operation specified by the instructions, such as an arithmetic operation, a logical operation, or a data transfer. In at least one embodiment, compute unit(s) 622 can execute instructions to perform any of the operations described herein. In at least one embodiment, compute unit(s) can include ALU(s) 624 (Arithmetic Logic Units), which may be used for performing arithmetic and logical operations. In at least one embodiment, compute unit(s) can include FPU(s) (Floating Point Units) 626, which may be used for performing floating-point calculations. In at least one embodiment, other circuits 628 can be used to perform other operations, such as vector and/or scalar operations. In at least one embodiment, accelerator(s) 630 can include one or more matrix multiplication accelerators, one or more parallel processing units (PPUs), such as GPUs, or any other accelerator or processor further described herein. In at least one embodiment, software program 604 can utilize one or more APIs and/or ISA instructions to perform various computing operations with accelerator(s) 630, such as matrix multiplication, arithmetic operations, or any other computing operation further described herein. In at least one embodiment, one or more computing operations using accelerator(s) 630 can include at least one or more groups of computing operations to be accelerated by execution at least in part by accelerator(s) 630, including to implement a generative AI to generate information related to a system (e.g., a manufacturing system), perform one or more neural networks (e.g., one or more language models) that implement the generative AI, and/or perform one or more other operations such as those described herein.

In at least one embodiment, system 600 can be used to perform one or more instructions that include functions or operations, such as those described in connection with FIGS. 1-5. In at least one embodiment, system 600 comprising one or more processors causes one or more circuits to implement a generative AI to generate information related to a system (e.g., a manufacturing system), perform one or more neural networks (e.g., one or more language models) that implement the generative AI, and/or otherwise perform operations described herein. In at least one embodiment, system 600 is included in and/or otherwise includes systems illustrated in FIGS. 1-5 to cause one or more circuits to implement a generative AI to generate information related to a system (e.g., a manufacturing system), perform one or more neural networks (e.g., one or more language models) that implement the generative AI, and/or otherwise perform operations described herein. In at least one embodiment, system 600 includes one or more hardware illustrated in FIGS. 7-10, such as to implement a generative AI to generate information related to a system (e.g., a manufacturing system), perform one or more neural networks (e.g., one or more language models) that implement the generative AI, and/or otherwise perform operations described herein.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example - the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features - such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 97A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R. s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

At least one embodiment of the disclosure can be described in view of the following clauses:

Clause 1. One or more processors comprising processing circuitry to: iteratively generate potential answers until an answer of the potential answers is determined to be responsive to one or more prompts, each iteration comprising: using one or more first neural networks to generate first output based at least on first information comprising the one or more prompts, the first output to comprise at least one of a first answer, a request for second information, or a request to generate a tool; one of: when the first output is the first answer, a potential answer for a current iteration includes the first answer; when the first output is the request for the second information, one or more additional prompts are generated and processed using the one or more first neural networks or one or more second neural networks until a second output of an iteration is another answer as the potential answer or a new request to generate a new tool used to obtain the potential answer; and when the first output is the request to generate the tool, the potential answer is generated using the one or more second neural networks that generate the tool based at least on the request to generate the tool, the potential answer to comprise results obtained by using the tool if the tool is generated and used to obtain the results; and determining whether the potential answer is responsive to the one or more prompts.

Clause 2. The one or more processors of clause 1, wherein processing the one or more additional prompts includes: obtaining a response to at least one of the one or more additional prompts from at least one of a user, a software, a system, or an Artificial Intelligence agent, and processing the response using at least one of the one or more first neural networks or the one or more second neural networks.

Clause 3. The one or more processors of clause 1 or 2, wherein at least one iteration comprises: using one or more third neural networks to generate at least one new prompt if the potential answer is determined not to be responsive to the one or more prompts; and using the one or more first neural networks to generate a request for third information from a requester based at least on the at least one new prompt, the first information to comprise a response to the request for third information.

Clause 4. The one or more processors of any one of clauses 1-3, wherein at least one iteration comprises: when the first output is the request to generate the tool, generating a cost estimate associated with using the tool, and obtaining an indication from a requester to proceed before using the one or more second neural networks to generate the tool.

Clause 5. The one or more processors of any one of clauses 1-4, wherein the one or more first neural networks are to use a contextual graph structure to generate the first output.

Clause 6. The one or more processors of any one of clauses 1-5, wherein at least one iteration comprises: detecting one or more anomalies in the potential answer; and generating a ticket for at least one of the one or more anomalies.

Clause 7. The one or more processors of any one of clauses 1-6, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models (MMLM); a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

Clause 8. A system comprising one or more processors to: repeat generating a potential answer until the potential answer is determined to be responsive to one or more prompts, generating the potential answer to comprise: using one or more neural networks to generate output based at least on first information comprising the one or more prompts, the output to comprise at least one of a first answer, a request for second information, or a request to generate a tool, the potential answer to comprise the first answer if the output comprises the first answer; using the one or more neural networks to generate the tool based at least on the request to generate the tool if the output comprises the request to generate the tool, the potential answer to comprise results obtained by using the tool if the tool is generated and used to obtain the results; and determining whether the potential answer is responsive to the one or more prompts.

Clause 9. The system of clause 8, wherein the generating the potential answer comprises: obtaining a response from a user to the request for the second information, the first information to comprise the response.

Clause 10. The system of clause 8 or 9, wherein the generating the potential answer comprises: using the one or more neural networks to generate at least one new prompt if the potential answer is determined not to be responsive to the one or more prompts; and using the one or more neural networks to generate a request for third information from a requester based at least on the at least one new prompt, the first information to comprise a response to the request for third information.

Clause 11. The system of any one of clauses 8-10, wherein generating the potential answer comprises: generating a cost estimate associated with using the tool; and obtaining an indication from a requester to proceed before using the one or more neural networks to generate the tool.

Clause 12. The system of any one of clauses 8-11, wherein the one or more neural networks are to use a contextual graph structure to generate the output.

Clause 13. The system of any one of clauses 8-12, wherein the generating the potential answer comprises: detecting one or more anomalies in the potential answer; and determining whether to cause one or more corrective actions to be taken with respect to at least one of the one or more anomalies.

Clause 14. The system of any one of clauses 8-13, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models (MMLM); a system implementing one or more large language models (LLMs); a system implementing one or more vision language models (VLMs); a system implementing one or more small language models (SLMs); a system for generating synthetic data; a system for generating synthetic data using AI; a system incorporating one or more virtual machines (VMs); a system implemented at least partially in a data center; or a system implemented at least partially using cloud computing resources.

Clause 15. A method comprising: using one or more first neural networks to generate output based at least on a first prompt, the output to comprise at least one of a first answer, a request for particular information, or a request to build a tool to obtain data, a potential answer to comprise the first answer if the output comprises the first answer; using one or more second neural networks to generate the tool based at least on the request to build the tool if the output comprises the request to build the tool, the potential answer to comprise the data obtained by using the tool if the tool is generated and used to obtain the data; determining whether the potential answer is responsive to the first prompt; and using the one or more first neural networks to obtain additional information if the potential answer is determined not to be responsive to the first prompt.

Clause 16. The method of clause 15, further comprising: using one or more third neural networks to generate a second prompt to be used by the one or more first neural networks to obtain the additional information.

Clause 17. The method of clause 15 or 16, further comprising: generating a cost estimate associated with using the tool to obtain the data; and obtaining an indication from a requester to proceed before using the one or more second neural networks to generate the tool.

Clause 18. The method of any one of clauses 15-17, further comprising: causing a user interface to display information requesting the particular information from a requester if the output comprises the request for the particular information.

Clause 19. The method of any one of clauses 15-18, further comprising: detecting one or more anomalies in the potential answer; and causing at least one action to be taken with respect to the one or more anomalies.

Clause 20. The method of any one of clauses 15-19, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models (MMLM); a system implementing one or more large language models (LLMs); a system implementing one or more vision language models (VLMs); a system implementing one or more small language models (SLMs); a system for generating synthetic data; a system for generating synthetic data using AI; a system incorporating one or more virtual machines (VMs); a system implemented at least partially in a data center; or a system implemented at least partially using cloud computing resources.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
iteratively generate potential answers until an answer of the potential answers is determined to be responsive to one or more prompts, each iteration comprising:
using one or more first neural networks to generate first output based at least on first information comprising the one or more prompts, the first output to comprise at least one of a first answer, a request for second information, or a request to generate a tool;
one of:
when the first output is the first answer, a potential answer for a current iteration includes the first answer;
when the first output is the request for the second information, one or more additional prompts are generated and processed using the one or more first neural networks or one or more second neural networks until a second output of an iteration is another answer as the potential answer or a new request to generate a new tool used to obtain the potential answer; and
when the first output is the request to generate the tool, the potential answer is generated using the one or more second neural networks that generate
the tool based at least on the request to generate the tool, the potential answer to comprise results obtained by using the tool if the tool is generated and used to obtain the results; and
determining whether the potential answer is responsive to the one or more prompts.

2. The one or more processors of claim 1, wherein processing the one or more additional prompts includes:
obtaining a response to at least one of the one or more additional prompts from at least one of a user, a software, a system, or an Artificial Intelligence agent, and processing the response using at least one of the one or more first neural networks or the one or more second neural networks.

3. The one or more processors of claim 1, wherein at least one iteration comprises:
using one or more third neural networks to generate at least one new prompt if the potential answer is determined not to be responsive to the one or more prompts; and
using the one or more first neural networks to generate a request for third information from a requester based at least on the at least one new prompt, the first information to comprise a response to the request for third information.

4. The one or more processors of claim 1, wherein at least one iteration comprises:
when the first output is the request to generate the tool, generating a cost estimate associated with using the tool, and obtaining an indication from a requester to proceed before using the one or more second neural networks to generate the tool.

5. The one or more processors of claim 1, wherein the one or more first neural networks are to use a contextual graph structure to generate the first output.

6. The one or more processors of claim 1, wherein at least one iteration comprises:
detecting one or more anomalies in the potential answer; and
generating a ticket for at least one of the one or more anomalies.

7. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLM);
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

8. A system comprising one or more processors to:
repeat generating a potential answer until the potential answer is determined to be responsive to one or more prompts, generating the potential answer to comprise:
using one or more neural networks to generate output based at least on first information comprising the one or more prompts, the output to comprise at least one of a first answer, a request for second information, or a request to generate a tool, the potential answer to comprise the first answer if the output comprises the first answer;
using the one or more neural networks to generate the tool based at least on the request to generate the tool if the output comprises the request to generate the tool, the potential answer to comprise results obtained by using the tool if the tool is generated and used to obtain the results; and
determining whether the potential answer is responsive to the one or more prompts.

9. The system of claim 8, wherein the generating the potential answer comprises:
obtaining a response from a user to the request for the second information, the first information to comprise the response.

10. The system of claim 8, wherein the generating the potential answer comprises:
using the one or more neural networks to generate at least one new prompt if the potential answer is determined not to be responsive to the one or more prompts; and
using the one or more neural networks to generate a request for third information from a requester based at least on the at least one new prompt, the first information to comprise a response to the request for third information.

11. The system of claim 8, wherein generating the potential answer comprises:
generating a cost estimate associated with using the tool; and
obtaining an indication from a requester to proceed before using the one or more neural networks to generate the tool.

12. The system of claim 8, wherein the one or more neural networks are to use a contextual graph structure to generate the output.

13. The system of claim 8, wherein the generating the potential answer comprises:
detecting one or more anomalies in the potential answer; and
determining whether to cause one or more corrective actions to be taken with respect to at least one of the one or more anomalies.

14. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLM);
a system implementing one or more large language models (LLMs);
a system implementing one or more vision language models (VLMs);
a system implementing one or more small language models (SLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A method comprising:
using one or more first neural networks to generate output based at least on a first prompt, the output to comprise at least one of a first answer, a request for particular information, or a request to build a tool to obtain data, a potential answer to comprise the first answer if the output comprises the first answer;
using one or more second neural networks to generate the tool based at least on the request to build the tool if the output comprises the request to build the tool, the potential answer to comprise the data obtained by using the tool if the tool is generated and used to obtain the data;
determining whether the potential answer is responsive to the first prompt; and
using the one or more first neural networks to obtain additional information if the potential answer is determined not to be responsive to the first prompt.

16. The method of claim 15, further comprising:
using one or more third neural networks to generate a second prompt to be used by the one or more first neural networks to obtain the additional information.

17. The method of claim 15, further comprising:
generating a cost estimate associated with using the tool to obtain the data; and
obtaining an indication from a requester to proceed before using the one or more second neural networks to generate the tool.

18. The method of claim 15, further comprising:
causing a user interface to display information requesting the particular information from a requester if the output comprises the request for the particular information.

19. The method of claim 15, further comprising:
detecting one or more anomalies in the potential answer; and
causing at least one action to be taken with respect to the one or more anomalies.

20. The method of claim 15, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLM);
a system implementing one or more large language models (LLMs);
a system implementing one or more vision language models (VLMs);
a system implementing one or more small language models (SLMs);
a system for generating synthetic data;
a system for generating synthetic data using AI;
a system incorporating one or more virtual machines (VMs);
a system implemented at least partially in a data center; or
a system implemented at least partially using cloud computing resources.
